(19) United States
(12) Patent Application Publication
(10) Pub. No.: US 2016/0277456 A1
(43) Pub. Date: Sep. 22, 2016

(54) CONDUCTING ONLINE MEETINGS USING AUGMENTED EQUIPMENT ENVIRONMENT

(71) Applicant: Citrix Systems, Inc., Fort Lauderdale, FL (US)

(72) Inventor: Ahmed Said Sallam, Cupertino, CA (US)

(21) Appl. No.: 14/661,062

(22) Filed: Mar. 18, 2015

(51) Int. Cl. H04L 29/06

(52) U.S. Cl. CPC H04L 65/403; H04L 65/1069; H04L 65/60

(57) ABSTRACT

Techniques for conducting online meetings involve expanding the scope of devices beyond basic peripheral devices, such as built-in cameras or displays, that are part of user computing devices serving as clients in online meeting sessions. A disclosed technique includes gathering device information for an augmented set of peripheral IO devices accessible to users, the augmented set of peripheral IO devices being separate from such basic peripheral devices. Gathered device information is stored in an augmented environment database, and the peripheral IO devices of the augmented set of peripheral devices are configured for use in the online meeting using the device information obtained from the augmented environment database, peripheral IO devices either replacing or supplementing corresponding peripheral devices of the basic set of peripheral devices for use in the online meeting.

### BACKGROUND

A typical web meeting shares visual content and audio content among multiple web meeting members. In particular, each web meeting member connects a respective user device to a central web meeting server over a computer network. Once the user devices of the web meeting members are connected with the central web meeting server, the members are able to watch visual content, as well as ask questions and inject comments to form a collaborative exchange even though the web meeting members may be scattered among different locations.

### SUMMARY

With modern trends of widespread use of electronic devices, users have more devices that are available to them for use in online meetings. For example, there are more mobile devices such as smartphones and tablet computers. There are also more specialized devices that incorporate intelligence so as to usable in conjunction with other computerized devices. Examples include devices such as smart televisions and cameras having WiFi or Bluetooth connectivity and programmability.

Advantageously, improved techniques for conducting online meetings involve expanding the scope of devices to be used in online meetings beyond those basic peripheral devices that are part of or otherwise intimately attached to the user computing devices serving as the clients in online meeting sessions. Such basic devices include attached video displays, built-in speakers, etc. The disclosed techniques provide for use of an augmented set of peripheral IO devices that are accessible to the users, either in a local area such as a home or office or even in a remote area, such as a remotely controlled camera or display. Accordingly, there can be much greater flexibility and richness in the manner of configuration and use of equipment in online meetings, enhancing the effectiveness and value of the meetings to the participants.

One embodiment is directed to a computer-implemented method of conducting an online meeting among users associated with respective user computing devices. The method includes gathering, by processing circuitry, device information for an augmented set of peripheral IO devices accessible to the users, the augmented set of peripheral IO devices being separate from a basic set of peripheral IO devices forming respective parts of respective ones of the user computing devices. The method further includes storing, by the processing circuitry, the device information in an augmented environment database, as well as configuring, by the processing circuitry, peripheral IO devices of the augmented set of peripheral devices for use in the online meeting using the device information obtained from the augmented environment database, the peripheral IO devices either replacing or supplementing corresponding peripheral IO devices of the basic set of peripheral IO devices for use in the online meeting.

In some arrangements, the gathering includes identifying and locating the peripheral IO devices and communicating with identified and located peripheral IO devices to receive the device information therefrom. In this respect, the peripheral IO devices may have respective wireless interfaces operative to communicate over respective wireless communication channels using standardized wireless communication protocols, and the identifying, locating and communicating with the peripheral IO devices includes using the respective wireless communication channels.

In some arrangements, the gathering includes accessing an enterprise database storing device information for devices owned or controlled by the organization and located at organization premises. The technique can thus leverage such existing device information to expand the scope of devices usable in the online meetings.

In some arrangements, the gathering is performed by the processing circuitry executing instructions of a peripheral IO device management application, and includes communicating with peripheral IO device communication agents on respective ones of the user computing devices, the peripheral IO device communication agents being operative to (1) communicate with respective associated ones of the augmented set of peripheral IO devices to obtain the device information therefrom, and (2) communicate the device information obtained from the respective associated ones of the augmented set of peripheral IO devices to the peripheral IO device management application.

In some arrangements, the augmented set of peripheral IO devices include audio and video devices, and the configuring includes establishing functional connections between the audio and video devices and respective user computing devices for use in capturing or rendering audio and video content in the online meeting. In this respect, the audio and video devices include things like microphones, cameras, speakers and video displays.

In some arrangements, the augmented set of peripheral IO devices include local devices at respective locations of respective user computing devices, and remote devices located away from but being accessible to respective user computing devices to be configured into online meetings involving respective users.

In some arrangements, the configuring includes dynamically beginning use of selected devices during respective online meetings.

In some arrangements, configuring is performed in part by the processing circuitry executing instructions of a visualization application working in conjunction with visualization agents on respective user computing devices, the visualization application operative to enable a user to design, orchestrate, and establish sets of connections among the user computing devices and the peripheral IO devices. The sets of connections can be stored as templates usable as starting points for creating other sets of connections.

In some arrangements, configuring is performed in part by the processing circuitry executing instructions of a policy engine working in conjunction with policy agents on respective user computing devices, the policy engine storing configuration policies and communicating policy information to the policy agents, the policy agents enforcing the configuration policies using the policy information as part of configuring the peripheral IO devices for use in online meetings. In this respect, the configuration policies may include one or more of security policies and power-management policies, the security policies defining permissible access to the peripheral IO devices, the power-management policies defining permissible operation of the peripheral IO devices to achieve power usage goals.

Another embodiment is directed to online meeting server equipment that includes a communications interface, memory, storage, and control circuitry coupled to the communications interface, memory and storage. The memory stores computer program instructions executed by the control circuitry to cause the online meeting server equipment to:
(A) gather, via the communication interface, device information for an augmented set of peripheral IO devices accessible to the users, the augmented set of peripheral IO devices being separate from a basic set of peripheral IO devices forming respective parts of respective ones of the user computing devices;
(B) store, in the storage, the device information in an augmented environment database; and
(C) configure, via the communication interface, peripheral IO devices of the augmented set of peripheral devices for use in the online meeting using the device information obtained from the augmented environment database, the peripheral IO devices either replacing or supplementing corresponding peripheral IO devices of the basic set of peripheral IO devices for use in the online meeting.

In some arrangements, the online meeting server equipment may incorporate additional features or specifics as outlined above for the computer-implemented method.

Another embodiment is directed to a computer program product having a non-transitory computer-readable medium storing a set of computer program instructions, the computer program instructions being executable by processing circuitry of computer equipment to cause the computer equipment to conduct an online meeting among users associated with respective user computing devices, by:
(A) gathering device information for an augmented set of peripheral IO devices accessible to the users, the augmented set of peripheral IO devices being separate from a basic set of peripheral IO devices forming respective parts of respective ones of the user computing devices;
(B) storing the device information in an augmented environment database; and
(C) configuring peripheral IO devices of the augmented set of peripheral devices for use in the online meeting using the device information obtained from the augmented environment database, the peripheral IO devices either replacing or supplementing corresponding peripheral IO devices of the basic set of peripheral IO devices for use in the online meeting.

In some arrangements, the computer program instructions on the computer-readable medium may cause the computer equipment to incorporate additional or more specific functions and features as outlined above for the computer-implemented method.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of a computer system;

FIG. 2 is a block diagram of online meeting server equipment;

FIG. 3 is a block diagram of a user computing device;

FIG. 4 is a schematic diagram of an enterprise device database;

FIG. 5 is schematic diagram of an augmented environment device database;

FIG. 6 is a flow diagram of operation of online meeting server equipment.

### DETAILED DESCRIPTION

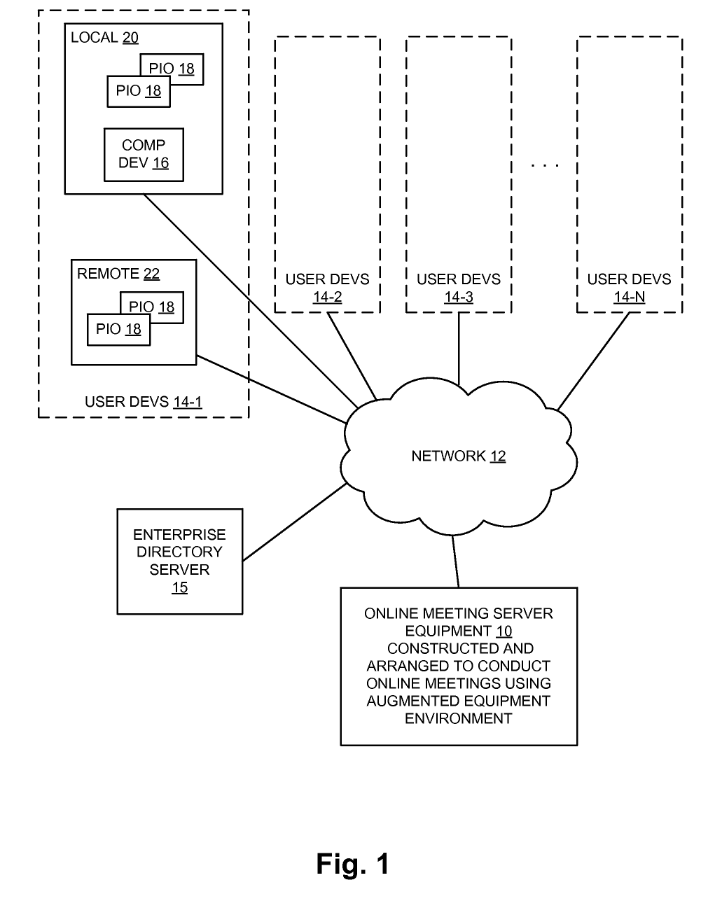

FIG. 1 shows a system in which online meetings or similar collaborative exchanges among system users are performed. The system includes online meeting server equipment 10 which is constructed and arranged to conduct online meetings using an augmented equipment environment as described herein. The online meeting server equipment 10 is connected to a network 12 to which are also connected different sets of user devices 14-x (x=1, 2, . . . n) , the sets being associated with respective users. That is, the set of user devices 14-1 is associated with a first user, the set of user devices 14-2 is associated with a second user, etc. As shown, the system may also include an enterprise directory server 15 whose use is described below.

Within each set of user devices 14 is one or more computing devices 16 and separate devices referred to as “peripheral I/O” (PIO) devices 18. A computing device 16 is capable of executing application software such as the client side of an online meeting application. Thus a computing device 16 has processing circuitry and memory storing such application software along with other software such as an operating system, device drivers, etc. Examples of computing devices 16 include a desktop or portable personal computer, tablet computer, smartphone, etc. A computing device 16 typically has its own directly connected I/O components, such as a display screen, a speaker, a built-in microphone and perhaps a built-in camera. The peripheral I/O devices 18 are separate from the computing device 16 and may have more limited, special-purpose processing capability. Examples of peripheral I/O devices 18 include standalone displays, cameras, and other audio/video devices. In some cases, the peripheral I/O devices 18 may be part of fuller-function devices that are used in only a limited way to provide desired functionality. An example using a tablet computer is explained below. At least some of the peripheral I/O devices 18 may have the ability to communicate with the computing device 16 or other external components using standardized protocols such as WiFI, Bluetooth®, Wireless Display (WiDi), Wireless Home Digital Interface (WHDI), AirPlay®, Google Play, Wireless USB, etc.

As shown, some of the peripheral I/O devices 18 are in a local area 20 of the computing device 16, e.g., in the same room or office, while others of the peripheral I/O devices 18 are in one or more remote areas 22 away from the computing device 16 but still accessible by the network 12. The remote area 22 might be a different office, for example, or it might be a home location if the computing device 16 is at a work location, or vice-versa.

In operation, users participate in online meetings by first establishing meeting sessions between their respective computing devices 16 and the online meeting server equipment 10. In conventional systems this is effectively the limit of connection, and the online meeting is conducted using the direct-attached peripheral devices of the users' computing devices 16 (i.e., attached computer display, built-in camera, etc.). In the system of FIG. 1, the equipment environment of online meetings is augmented by selective incorporation of the peripheral I/O devices 18, providing much greater flexibility and richness in the manner of setting up and conducting the online meetings. Details of the discovery, configuration and use of the augmented equipment environment are described more below.

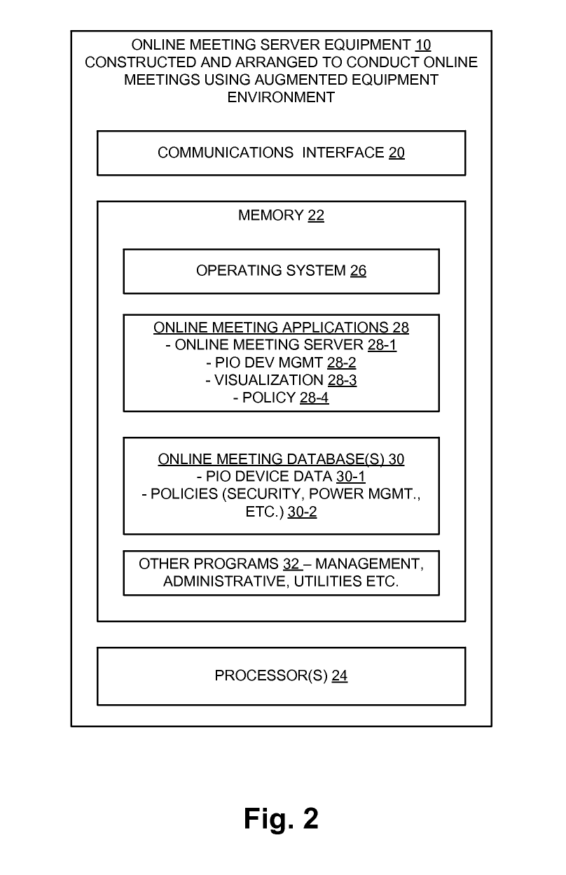

FIG. 2 shows the online meeting server equipment 10. It is typically realized by one or more computers, e.g., server computers, which may be located in a corporate data center, web farm, cloud computing facility(ies), or some mixture thereof. The equipment includes a communications interface 20, memory 22 and processor(s) 24. The memory 22 and processors 24 collectively form processing circuitry that executes application software and other computer program instructions to realize functionality as described herein. The communications interface 20 provides connections to the network 12 and perhaps other external systems or devices, such as locally attached secondary storage (not shown) for example.

As shown, the memory 22 stores software including an operating system 26 and online meeting applications 28 that are executed by the processors 24. The online meeting applications 28 include an online meeting server 28-1 that provides the core online meeting experience, i.e., receiving, mixing and distributing audio and video, presenting control and monitoring interfaces to participants, etc. The online meeting applications 28 also include applications that participate in creating and using the augmented equipment environment. These can include a peripheral I/O

(PIO) device management application 28-2, a visualization application 28-3 usable to configure specific augmented equipment arrangements for particular meetings, users, etc., and a policy engine 28-4 that is responsible for communication and use of policies in the configuration and use of the peripheral I/O devices 18.

The memory 22 also stores data that is used by the online meeting applications 28, shown as online meeting databases 30. These include a PIO device data database 30-1 as well as a policies database 30-2. As described more below, the PIO device data database 30-1 stores information about the peripheral I/O devices 18 to enable them to be deployed in online meetings. The policies database 30-2 stores policy information that may be provided by a system administrator for example. The policy information describes organization-specified rules or policies for the use of the peripheral I/O devices 18 in online meetings. Example policy domains include security and power management. Examples are given below.

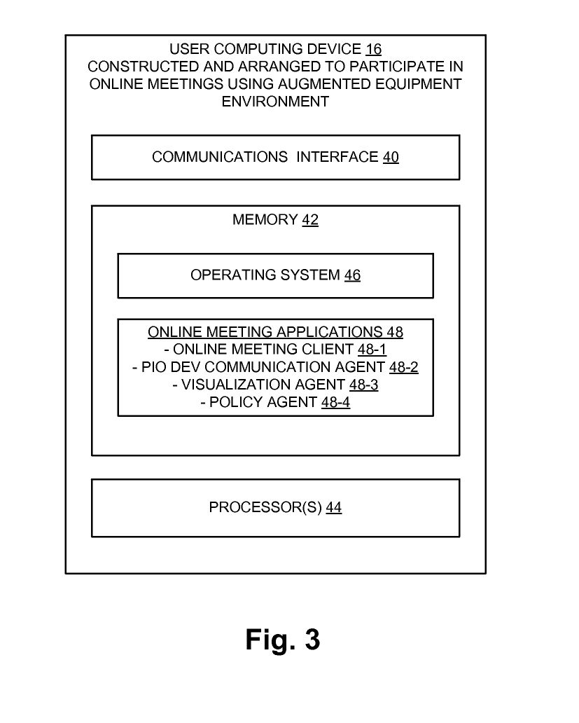

FIG. 3 shows a user computing device 16. As mentioned above, it is typically a personal computing device such as a personal computer, tablet computer, etc. It may have a fixed location, such as a user's home or office, or it may be a mobile device. The computing device 16 includes a communications interface 40, memory 42 and processor(s) 44. The memory 42 and processors 44 collectively form processing circuitry that executes application software and other computer program instructions to realize functionality as described herein. The communications interface 40 provides connections to the network 12 and perhaps other external systems or devices. In particular, the communications interface 40 provides functional connections to the peripheral I/O devices 18 of the user, i.e., interfaces such as the above-mentioned wireless interfaces for example. By these connections or interfaces, the computing device 16 can discover the peripheral I/O devices 18, obtain device data such as data regarding capabilities, and exercise control as part of configuring the devices for use in online meetings under higher-level control of the online meeting server equipment 10 as describe more below.

As shown, the memory 42 stores software including an operating system 46 and online meeting applications 48 that are executed by the processors 44. The online meeting applications 48 include an online meeting client 48-1 that works with the online meeting server 28-1 of the online meeting server equipment 10 to provide the core online meeting experience to the local user, i.e., forwarding locally captured audio and video to the online meeting server equipment 10 and receiving and rendering mixed audio and video that is generated by the online meeting server equipment 10 and distributed to the participants. The online meeting applications 48 also include applications that participate in creating and using the augmented equipment environment. These can include a PIO device communication agent 48-2, a visualization agent 48-3, and a policy agent 48-4, each working in conjunction with a counterpart application 28-2, 28-3, 28-4 of the online meeting server equipment 10 to provide corresponding end-to-end functionality.

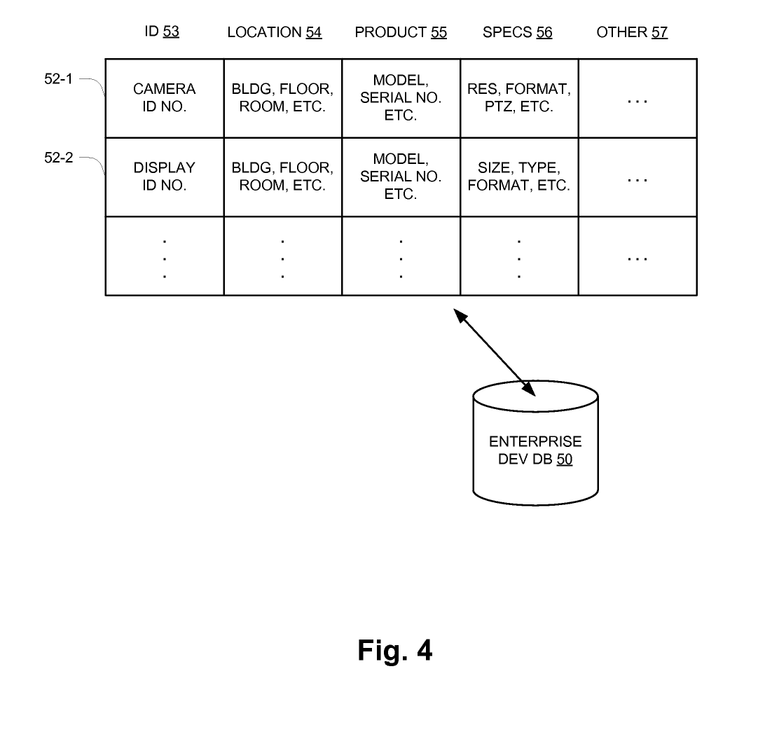

FIG. 4 illustrates certain data that can be used in creating an augmented equipment environment as described herein. Specifically, an enterprise device database (DEV DB) 50 stores a variety of data about peripheral I/O devices 18 that are owned or otherwise controlled by an enterprise, such as a corporation or other business that deploys and operates the online meeting server equipment 10 to provide online meeting services usable by its employees, customers, etc. The enterprise device database 50 is part of the enterprise directory server 15 of FIG. 1, and is accessible to the online meeting server equipment 10 via the network 12.

FIG. 4 shows example records 52-1, 52-2 of the enterprise device database 50. As indicated at the top, the fields for the records 52 include an identity (ID) field 53, location field 54, product field 55, specifications (SPECS) field 56, and other fields 57. The identity field 53 includes information identifying a particular peripheral I/O device. In the illustrated example this field includes a description such as “camera” or “display” for the device as well as an associated ID number, which may be assigned by the system for purposes of distinguishing the device from all other devices. The location field 54 includes location information such as building, floor, room/office, etc. The product field 55 contains information identifying the device as a distinct product. For example, there may be a model name or number, a manufacturer's serial number, etc. The specifications field 56 provides data regarding the capabilities of the device. For the example camera record 52-1, this information might include the resolution (RES), format (e.g., SD/HD, aspect ratio), whether it has pan/tilt/zoom (PTZ) functionality, etc. The example display record 52-2 includes analogous information for a display device.

The online meeting applications 28 may treat the presence and contents of the enterprise device database 50 as given, created and maintained by an external actor and used in configuring augmented equipment environments. For example, there may be a database application and a specific manager or administrator in the organization who is responsible for maintaining the enterprise device database 50, apart from its connection or use with online meetings or any other application. Alternatively, the online meeting applications 28 may be involved in some manner in maintaining the enterprise device database 50, such as for example providing device information gathered as part of the online meeting operations. The enterprise device database 50 provides at least a query interface that enables the online meeting applications 28 to retrieve device data for use in setting up and using augmented equipment environments for online meetings.

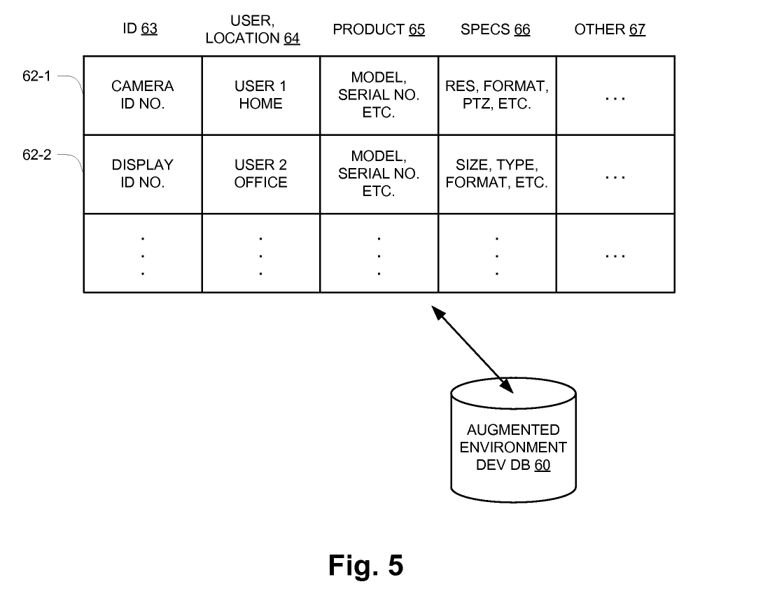

FIG. 5 illustrates certain additional data that can be used in creating an augmented equipment environment as described herein. Specifically, an augmented environment device database (DEV DB) 60 stores a variety of data about peripheral I/O devices 18 that are not owned or controlled by the enterprise but are accessible to users in some manner that enables them to be included in augmented equipment environments. Examples of such devices include other personal computing devices owned by a user, such as a tablet computer or smartphone for example. Other examples includes devices such as displays, cameras, microphones, etc. that are accessible via corresponding communication connections as described above. In the case of other personal computing devices, it should be understood that in this context they are used only for their peripheral I/O functionality and not for their ability to serve as the user computing device 16 that executes the online meeting client 48-1. Taking an example, a user may be using her desktop computer as the computing device 16 executing online meeting client 48-1 in a given online meeting, but for some reason would prefer to use the display of her tablet computer rather than the display of the desktop computer. The display of the tablet computer is available as a display-type peripheral I/O device 18 and can be configured into the augmented equipment environment as a display that replaces or supplements the display of the desktop computer. That is, the video delivered to this user is rendered on the display of the tablet computer as a local peripheral I/O device 18, either instead of or in addition to being rendered on the display of the desktop computer functioning as the computing device 16.

The augmented environment database 60 is part of the online meeting databases 30 and is maintained by the online meeting applications 28, specifically by the PIO device management application 28-2 working in conjunction with the PIO device communication agent 48-2 on the user computing device 16. Details of this operation are provided below.

FIG. 5 shows example records 62-1, 62-2 of the augmented environment database 60. As indicated, the fields for the records 62 include an identity (ID) field 63, user and location field 64, product field 65, specifications (SPECS) field 66, and other fields 67. The identity, product, and specifications fields 63, 65, 66 may store contents similar to those stored in the corresponding fields 53, 55, 56 as described above for the records 52 of the enterprise device database 50. The user and location field 64 stores information identifying a user that is associated with the device as well as the device's location. By “associated” is meant accessible in some manner via the user computing device 16 of a specific user as opposed to that of other users. That is, the device is within the set of devices 14-i for the specific user-i, either in a local area 20 or a remote area 22 with respect to the user (FIG. 1). The device might be personally owned by the user for example. Location information may identify specific locations associated with the user, e.g., office or home.

As mentioned, the augmented environment database 60 is maintained by the online meeting applications 28, and thus provides a write/update type of interface used by the online meeting applications 28 for that purpose. The augmented environment database 60 also provides a query interface that enables the online meeting applications 28 to retrieve device data for use in setting up and using augmented equipment environments for online meetings.

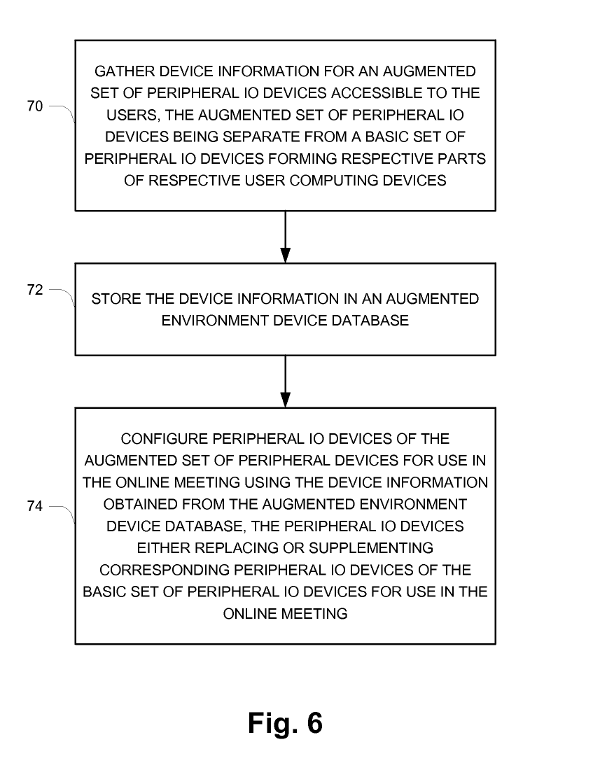

FIG. 6 illustrates high-level operation of the online meeting server equipment 10, specifically the processing circuitry (memory 22 and processors 24) executing the online meeting applications 28.

At 70, the processing circuitry gathers device information for an augmented set of peripheral IO devices accessible to the users, the augmented set of peripheral IO devices being separate from a basic set of peripheral IO devices forming respective parts of respective ones of the user computing devices. The augmented/basic distinction is outlined above with reference to FIG. 1, i.e., the peripheral I/O devices 18 (either local or remote) as distinct from built-in I/O components (camera, etc.) of the user computing device 16. The device information is gathered by the PIO device management application 28-2 of online meeting server equipment 10 (FIG. 2) working in conjunction with the PIO device communication agent 48-2 of user computing device 16 (FIG. 3). More specifically, the PIO device communication agent 48-2 communicates with the peripheral I/O devices 18 using the respective communication protocols (e.g., the wireless protocols discussed above), and using these protocols identifies and locates the devices and reads their device data, then forwards this information on to the peripheral I/O management application 28-2.

At 72, the processing circuitry stores the device information in an augmented environment database, e.g., the database 50 (FIG. 4).

At 74, the processing circuitry configures the peripheral IO devices of the augmented set of peripheral devices for use in an online meeting using device information obtained from the augmented environment database, causing the peripheral IO devices to either replace or supplement corresponding peripheral IO devices of the basic set of peripheral IO devices for use in the online meeting. Referring again to the above example, a scenario is assumed in which a user's tablet computer is to be used to display the online meeting video. In this case, the PIO device management application 28-2 of the online meeting server equipment 10 has knowledge of the tablet computer via the augmented environment device database 60 and issues control commands to the online meeting client 48-1 and PIO device communication agent 48-2 to effect the redirection of the session video being delivered by the online meeting server 28. The PIO device communication agent 48-2 communicates with the tablet computer to configure it to receive the video via a communication link from the computing device 16 and to render the video on the tablet's display. The online meeting client 48-2 reconfigures itself to direct the session video to the communication link to the tablet, either instead of or in addition to delivering it to the local display of the computing device 16 (i.e., desktop computer in this example).

It should be noted that the configuring at 74 may be done only prior to initiation of an online meeting, or the system may be capable of dynamically configuring peripheral IO devices of the augmented set of peripheral IO devices for use at any time, including after a meeting has started. Such dynamic capability provides additional flexibility and convenience to users.

Beyond the low-level configuring of peripheral IO devices 18 for use in online meetings as described above, the online meeting applications 28 and 48 also provide additional functionality for efficiency and richness as well as in support of other aspects of system operation, e.g., security.

The visualization application 28-3 and visualization agent 48-3 provide functions enabling a user or administrator to design, orchestrate and establish sets of connections among computing devices 16 and peripheral IO devices 18, which can then be realized by lower-level configuration operations of the type described above. Once a set of connections is defined, it can also be saved as a template that can serve as a starting point for defining other sets of connections. Sets and templates can be stored in association with specific users or user computing devices 16, for example, and thus be more readily utilized/deployed when the associated user participates in a meeting. Alternatively, sets and/or templates can be defined for recurring meetings or for archetypes of meetings, e.g., an engineering or sales team meeting, project management meeting, quarterly investor/advisor meeting, etc.

The policy application 28-4 and policy agent 48-4 provide functions enabling an administrator to apply policies and to have those policies enforced during operation. In the security domain, policies may be used to address issues such as access control and privacy. As an example, it can be specified that only certain users are allowed to use certain enterprise devices identified in the enterprise device database 50, or that the devices can only be used under certain circumstances e.g., during regular business hours or only if a VP is participating in the meeting. In another example, the system may limit the manner in which certain peripheral IO devices 18 can be used, to reduce exposure to security risks. Another domain is power management. Policies may specify preferences for lower-power devices to be used when available, or that devices must be powered off when not in actual meeting use. Generally, the policy application 28-2 is responsible for maintaining policy information and for forwarding it to the locations of enforcement, which can include the PIO device management application 28-2 and the policy agent 48-4 working together with the PIO device communication agent 48-2 and online meeting client 48-1.

While various embodiments of the invention have been particularly shown and described, it will be understood by those skilled in the art that various changes in form and details may be made therein without departing from the spirit and scope of the invention as defined by the appended claims.

What is claimed is:

1. A computer-implemented method of conducting an online meeting among users associated with respective user computing devices, comprising:
gathering, by processing circuitry, device information for an augmented set of peripheral IO devices accessible to the users, the augmented set of peripheral IO devices being separate from a basic set of peripheral IO devices forming respective parts of respective ones of the user computing devices;
storing, by the processing circuitry, the device information in an augmented environment database; and
configuring, by the processing circuitry, peripheral IO devices of the augmented set of peripheral devices for use in the online meeting using the device information obtained from the augmented environment database, the peripheral IO devices either replacing or supplementing corresponding peripheral IO devices of the basic set of peripheral IO devices for use in the online meeting.

2. The computer-implemented method of claim 1, wherein the gathering includes identifying and locating the peripheral IO devices and communicating with identified and located peripheral IO devices to receive the device information therefrom.

3. The computer-implemented method of claim 2, wherein the peripheral IO devices have respective wireless interfaces operative to communicate over respective wireless communication channels using standardized wireless communication protocols, and wherein identifying, locating and communicating with the peripheral IO devices includes using the respective wireless communication channels.

4. The computer-implemented method of claim 1, wherein gathering includes accessing an enterprise database storing device information for devices owned or controlled by the organization and located at organization premises.

5. The computer-implemented method of claim 1, wherein the gathering is performed by the processing circuitry executing instructions of a peripheral IO device management application, and wherein gathering includes communicating with peripheral IO device communication agents on respective ones of the user computing devices, the peripheral IO device communication agents being operative to (1) communicate with respective associated ones of the augmented set of peripheral IO devices to obtain the device information therefrom, and (2) communicate the device information obtained from the respective associated ones of the augmented set of peripheral IO devices to the peripheral IO device management application.

6. The computer-implemented method of claim 1, wherein the augmented set of peripheral IO devices include audio and video devices, and wherein configuring the peripheral IO devices includes establishing functional connections between the audio and video devices and respective user computing devices for use in capturing or rendering audio and video content in the online meeting.

7. The computer-implemented method of claim 6, wherein the audio and video devices include microphones, cameras, speakers and video displays.

8. The computer-implemented method of claim 1, wherein the augmented set of peripheral IO devices include local devices at respective locations of respective user computing devices, and remote devices located away from but being accessible to respective user computing devices to be configured into online meetings involving respective users.

9. The computer-implemented method of claim 1, wherein configuring the augmented set of peripheral IO devices includes dynamically beginning use of selected devices during respective online meetings.

10. The computer-implemented method of claim 1, wherein configuring is performed in part by the processing circuitry executing instructions of a visualization application working in conjunction with visualization agents on respective user computing devices, the visualization application operative to enable a user to design, orchestrate, and establish sets of connections among the user computing devices and the peripheral IO devices.

11. The computer-implemented method of claim 1, wherein configuring is performed in part by the processing circuitry executing instructions of a policy engine working in conjunction with policy agents on respective user computing devices, the policy engine operative to store configuration policies and communicate policy information to the policy agents, the policy agents operative to enforce the configuration policies using the policy information as part of configuring the peripheral IO devices for use in online meetings.

12. The computer-implemented method of claim 11, wherein the configuration policies include one or more of security policies and power-management policies, the security policies defining permissible access to the peripheral IO devices, the power-management policies defining permissible operation of the peripheral IO devices to achieve power usage goals.

13. Online meeting server equipment, comprising:
a communications interface;
memory;
storage; and
control circuitry coupled to the communications interface, memory and storage, the memory storing computer program instructions executed by the control circuitry to cause the online meeting server equipment to:
gather, via the communication interface, device information for an augmented set of peripheral IO devices accessible to the users, the augmented set of peripheral IO devices being separate from a basic set of peripheral IO devices forming respective parts of respective ones of the user computing devices;
store, in the storage, the device information in an augmented environment database; and
configure, via the communication interface, peripheral IO devices of the augmented set of peripheral devices for use in the online meeting using the device information obtained from the augmented environment database, the peripheral IO devices either replacing or supplementing corresponding peripheral IO devices of the basic set of peripheral IO devices for use in the online meeting.

14. The online meeting server equipment of claim 13, wherein the gathering includes identifying and locating the peripheral IO devices and communicating with identified and located peripheral IO devices to receive the device information therefrom, the peripheral IO devices having respective wireless interfaces operative to communicate over respective wireless communication channels using standardized wireless communication protocols, and wherein identifying, locating and communicating with the peripheral IO devices includes using the respective wireless communication channels.

15. The online meeting server equipment of claim 13, wherein the gathering is performed by the processing circuitry executing instructions of a peripheral IO device management application, and wherein gathering includes communicating with peripheral IO device communication agents on respective ones of the user computing devices, the peripheral IO device communication agents being operative to (1) communicate with respective associated ones of the augmented set of peripheral IO devices to obtain the device information therefrom, and (2) communicate the device information obtained from the respective associated ones of the augmented set of peripheral IO devices to the peripheral IO device management application.

16. The online meeting server equipment of claim 13, wherein the augmented set of peripheral IO devices include audio and video devices, and wherein configuring the peripheral IO devices includes establishing functional connections between the audio and video devices and respective user computing devices for use in capturing or rendering audio and video content in the online meeting, the audio and video devices include microphones, cameras, speakers and video displays.

17. The online meeting server equipment of claim 13, wherein the augmented set of peripheral IO devices include local devices at respective locations of respective user computing devices, and remote devices located away from but being accessible to respective user computing devices to be configured into online meetings involving respective users.

18. The online meeting server equipment of claim 13, wherein configuring is performed in part by the processing circuitry executing instructions of a visualization application working in conjunction with visualization agents on respective user computing devices, the visualization application operative to enable a user to design, orchestrate, and establish sets of connections among the user computing devices and the peripheral IO devices.

19. The online meeting server equipment of claim 13, wherein configuring is performed in part by the processing circuitry executing instructions of a policy engine working in conjunction with policy agents on respective user computing devices, the policy engine operative to store configuration policies and communicate policy information to the policy agents, the policy agents operative to enforce the configuration policies using the policy information as part of configuring the peripheral IO devices for use in online meetings, the configuration policies including one or more of security policies and power-management policies, the security policies defining permissible access to the peripheral IO devices, the power-management policies defining permissible operation of the peripheral IO devices to achieve power usage goals.

20. A computer program product having a non-transitory computer-readable medium storing a set of computer program instructions, the computer program instructions being executable by processing circuitry of computer equipment to cause the computer equipment to conduct an online meeting among users associated with respective user computing devices, by:
gathering, by the processing circuitry, device information for an augmented set of peripheral IO devices accessible to the users, the augmented set of peripheral IO devices being separate from a basic set of peripheral IO devices forming respective parts of respective ones of the user computing devices;
storing, by the processing circuitry, the device information in an augmented environment database; and
configuring, by the processing circuitry, peripheral IO devices of the augmented set of peripheral devices for use in the online meeting using the device information obtained from the augmented environment database, the peripheral IO devices either replacing or supplementing corresponding peripheral IO devices of the basic set of peripheral IO devices for use in the online meeting.
